(19) United States
(12) Patent Application Publication
(10) Pub. No.: US 2008/0163759 A1
(43) Pub. Date: Jul. 10, 2008

(54) Slot machine toaster

(76) Inventors: Ron Meiry, Upland, CA (US); Ronen Tregerman, Las Vagas, NV (US)

Correspondence Address: LAW OFFICES OF ERIC KARICH, 2807 ST. MARK DR., MANSFIELD, TX, 76063, US

(21) Appl. No.: 11/649,978

(22) Filed: Jan. 5, 2007

(51) Int. Cl. G07F 9/10

(52) U.S. Cl. 99/357

(57) ABSTRACT

A useful device adapted to resemble a slot machine includes a device body having a useful feature for performing a task. A façade of the device body is adapted to resemble a slot machine. A slot arm operably connected to the device body functions to actuate the useful feature of the useful device.

### CROSS-REFERENCE TO RELATED APPLICATIONS

Not Applicable

### STATEMENT REGARDING FEDERALLY SPONSORED RESEARCH

Not Applicable

### BACKGROUND OF THE INVENTION

1. Field of the Invention

This invention relates generally to domestic devices, and more particularly to domestic devices such as toasters, pepper dispensers, coffee machines, and the like, adapted to resemble a slot machine.

2. Description of Related Art

Slot machines, poker machines, fruit machines, or similar or related gaming machines, are types of casino games that are coin-operated machines with three or more reels, which spin when a lever on the side of the machine is pulled. The slot machine is also known informally as a one-armed bandit because of its traditional appearance and its ability to leave the gamer penniless.

The machines include a currency detector that validates the money inserted to play. The machine typically pays off based on symbols visible on the reels when they stop. Modern computer technology has resulted in many variations on the slot machine concept. Today, slot machines are the most popular gambling method in casinos and constitute well over 50% of the average casino's income.

Many gamblers would like to take home a memento of a trip to a gambling location, such as Las Vegas, and a device that includes a slot machine would make an excellent memento or gift.

The prior art teaches various forms and types of slot machines. However, the prior art does not teach a slot machine integrated with a useful domestic machine or tool, like a toaster. The present invention fulfills these needs and provides further related advantages as described in the following summary.

### SUMMARY OF THE INVENTION

The present invention teaches certain benefits in construction and use which give rise to the objectives described below.

The present invention provides a useful device adapted to resemble a slot machine. The useful device includes a device body having a useful feature for performing a task. A façade of the useful device is adapted to resemble a slot machine. A slot arm is operably connected to the device body. The slot arm functions to actuate the useful feature of the useful device.

A primary objective of the present invention is to provide a useful device such as a toaster having advantages not taught by the prior art.

Another objective is to provide a useful device that includes a façade that is adapted to resemble a slot machine.

A further objective is to provide a useful device that includes a slot arm for actuating a useful feature of the useful device.

Other features and advantages of the present invention will become apparent from the following more detailed description, taken in conjunction with the accompanying drawings, which illustrate, by way of example, the principles of the invention.

### BRIEF DESCRIPTION OF THE DRAWING

The accompanying drawings illustrate the present invention. In such drawings:

FIG. 1 is a perspective view of a slot machine toaster according to a preferred embodiment of the present invention;

FIG. 2 is a front elevational view thereof;

FIG. 3 is a rear elevational view thereof, with a portion of the slot machine toaster broken away to illustrate internal components of the toaster;

FIG. 4 is a perspective view of a slot machine shaped pepper dispenser according to a second embodiment of the present invention;

FIG. 5 is a front elevational view thereof;

FIG. 6 is a rear elevational view thereof, with a portion of the pepper dispenser broken away to illustrate a pepper grinding mechanism of the pepper dispenser;

FIG. 7 is a perspective view of a slot coffee machine according to a third embodiment of the present invention;

FIG. 8 is a front elevational view thereof; and

FIG. 9 is a side elevational view thereof, with a portion of the slot coffee machine broken away to illustrate the internal construction of the slot coffee machine.

### DETAILED DESCRIPTION OF THE INVENTION

The above-described drawing figures illustrate the invention, a useful device 10 adapted to resemble a slot machine. As used in this application, the term “useful device” may include any form of domestic device, tool, or appliance that performs a task, such as a toaster 10, a pepper dispenser 50, a coffee machine 70, or similar article found and used in the home in a home, office, hotel, or similar location.

In general, the useful device 10 includes a device body 12 having a useful feature 14 for performing a task. A façade of the useful device 10 is adapted to resemble a slot machine. A slot arm 16 is operably connected to the device body 12. The slot arm 16 functions to actuate the useful feature 14 of the useful device 10. The slot arm 16 may also actuate a plurality of reels 26, as with a standard slot machine.

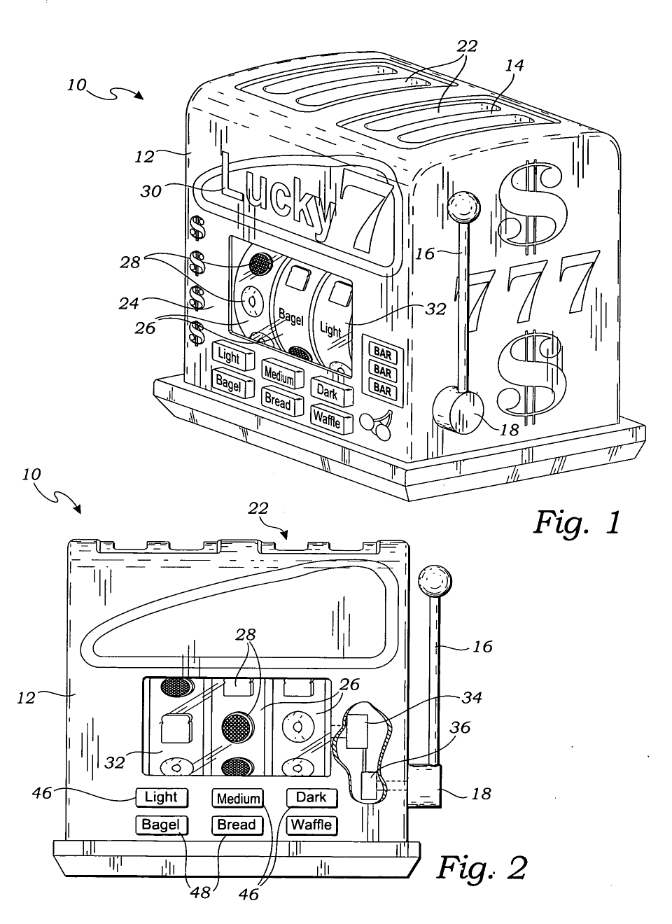

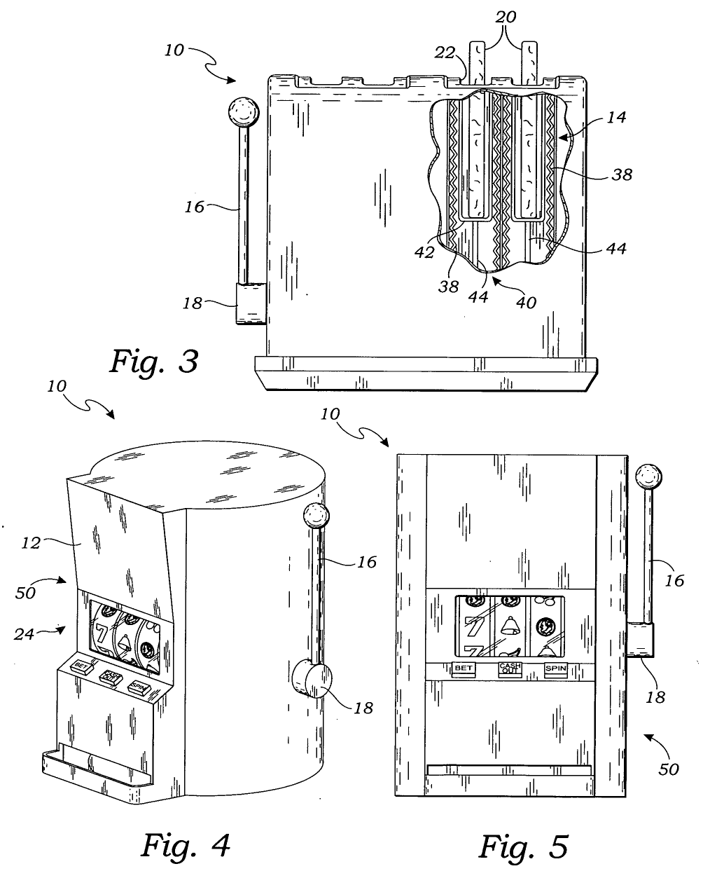

As illustrated in FIGS. 1-3, in one embodiment the useful device 10 is a toaster 10. FIG. 1 is a perspective view of the toaster 10 according to a preferred embodiment of the present invention. FIG. 2 is a front elevational view of the toaster 10, and FIG. 3 is a rear elevational view thereof. A portion of the slot machine toaster 10 is broken away in FIG. 3, to illustrate internal components of the toaster 10.

As illustrated in FIGS. 1-3, the toaster 10 is adapted for toasting a food product 20, such as a slice of bread, a waffle, a bagel, or similar product. The toaster 10 includes a toaster body 12 having an aperture 22 (typically 2-4 slots) for receiving the food product 20. The toaster body 12 is typically generally shaped like a rectangular parallelepiped, generally similar to prior art toasters 10, although modified to more closely resemble a slot machine. Alternative shapes may also be used, and should be considered within the scope of the present invention.

A façade of the toaster body 12, in cooperation with the slot arm 16, is adapted to make the toaster 10 resemble a slot machine. The façade may include a plurality of reels 26, each reel 26 including a plurality of slot symbols 28 printed or otherwise formed on the reel 26. In this embodiment, the slot symbols 28 include food products 20 such as toast, bagels, and waffles. In alternative embodiments, the slot symbols 28 may include more traditional symbols, such as fruit, bars, the number “7,” and similar symbols. For purposes of this application, the term “printed” is defined to include adhering stickers, etching, any form of printing, molding, or any other or equivalent means of marking or forming the symbols on the reels 26.

The façade may also include shapes and symbols 30 common to the gaming industry, printed or otherwise formed on the toaster body 12. Those skilled in the art may devise many alternative constructions and arrangements of symbols and elements that may the toaster body 12 resemble the body of a slot machine, and such alternatives should be considered within the scope of the present invention.

In one embodiment, illustrated in FIGS. 1 and 2, three reels 26 are rotatably mounted within the toaster body 12 and visible though a window 32. The reels 26 may be actuated by a spin mechanism 34 such as a motor for spinning the plurality of reels 26, and a control mechanism 36 for spinning the reels 26 and for stopping each of the plurality of reels 26 at various periods of time. The control mechanism 36 is operably controlled by the pull arm. In an alternative embodiment, the reels 26 are merely printed on the toaster body 12.

As illustrated in FIG. 3, the useful feature 14 of the slot machine toaster 10 includes a heater element 38 operably mounted within the toaster body 12, and a food holding mechanism 40 for receiving the food product 20 through the aperture 22. The food holding mechanism 40 is typically a wire cage 42 mounted on a track 44 for lowering the cage 42 into the toaster body 12. The general construction of the heater element 38 and the food holding mechanism 40 are well known in the art of toaster 10 construction, and is therefore not described herein in greater detail.

The slot arm 16 is operably connected to the toaster body 12 with a pivot 18, so that the slot arm 16 can pivot 18 with respect to the toaster body 12. The slot arm 16 functions to actuate the food holding mechanism 40 for lowering the food product 20 into the toaster body 12 adjacent the heater element 38, and for turning on the heater element 38.

In the most preferred embodiment, as shown in FIG. 2, the toaster 10 further includes a first control mechanism 46 for controlling the length of time the food product 20 is cooked. In one embodiment, the first control mechanism 46 includes a plurality of buttons for determining the degree that the food product 20 is cooked, indicating if the food product 20 is be cooked “light,” medium,” or “dark.” The toaster 10 preferably further includes a second control mechanism 48 for modifying the time and/or temperature of the cooking parameters, preferably a plurality of buttons that indicate specific food products, such as “bagel,” “bread,” and “waffle.” Obviously, the control mechanisms 46 and 48 could also be knobs or other forms of controls, and the mechanisms could indicate other references to guide uses in the operation of the toaster 10.

In the most preferred embodiment, illustrated in FIG. 1, the reels 26 may have slot symbols 28 that include textual descriptions of the food products 20. For example, if the toaster 10 is set to toast a bagel at the light setting, when the toast is done toasting, one of the slot symbols 28 could include the text “Bagel” and another of the slot symbols 28 could include the text “Light.” The control mechanism 36 would be programmed, in this case, to make the reels 26 spin until the bagel has finished toasting, and then stop the reels 26 so that these slot symbols 28 are at the front, as shown in FIG. 1.

The toaster 10 may also include additional elements to enhance the desirability of the product. For example, toasting plates (not shown) could be included in the toaster 10 to darken the food product 20 in a pattern to produce a certain marking, trademark, logo, or similar feature on the food product 20. In one embodiment, for example, the food product 20 such as a piece of toast could be darkened to form “7-7-7” or a similar gambling symbol. It could also be darkened to form a logo for a given casino, or other business.

For purposes of this application, the term slot machine is hereby defined to include any form of slot machine, poker machine, “fruit machine,” or related form of casino game consistent with the spirit of the present invention.

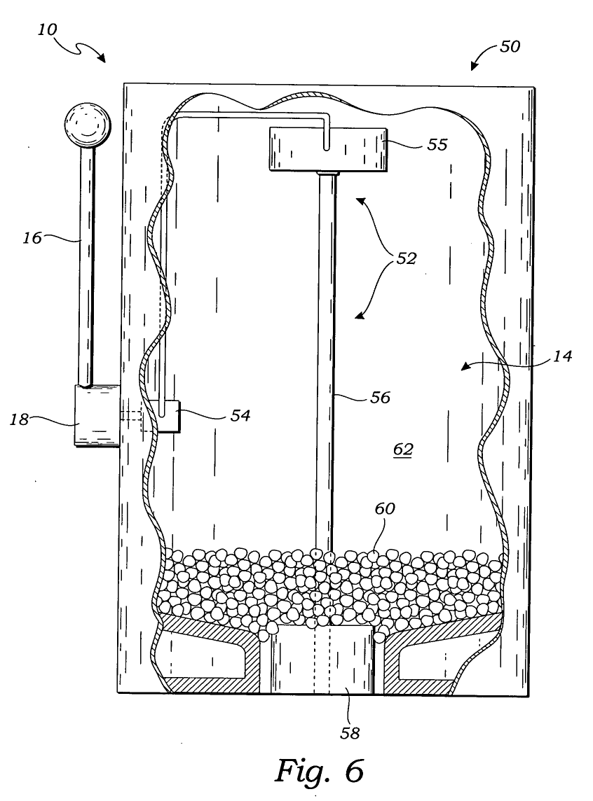

In the embodiment of FIGS. 4-6, the useful device 10 is a pepper dispenser 50, and the useful feature 14 is a pepper grinding mechanism 52 for grinding and dispensing pepper. FIG. 4 is a perspective view of the pepper dispenser 50, shaped like a slot machine, according to a second embodiment of the present invention. FIG. 5 is a front elevational view thereof, and FIG. 6 is a rear elevational view thereof. FIG. 6 illustrates a portion of the pepper dispenser 50 broken away to show the pepper grinding mechanism 52 within the pepper dispenser 50.

The slot arm 16 functions to activate and/or actuate the pepper grinding mechanism 52. In one embodiment, the slot arm 16 actuates a controller 54 that actuates a pepper grinding motor 55 that turns a shaft 56 that turns a grinding element 58. Peppercorn 60 within an internal chamber 62 is ground by the grinding element 58 and falls from the bottom of the pepper dispenser 50. In an alternative embodiment (not illustrated), the slot arm 16 directly and manually actuates the grinding element 58, through gears or similar mechanism, such as may be devised by one skilled in the art. Since the general construction of pepper dispensers 50 (or pepper grinders) are well known in the art, this aspect of the invention is not discussed in greater detail herein, and various alternative embodiments of the pepper dispenser 50 mechanisms should be considered within the scope of the present invention.

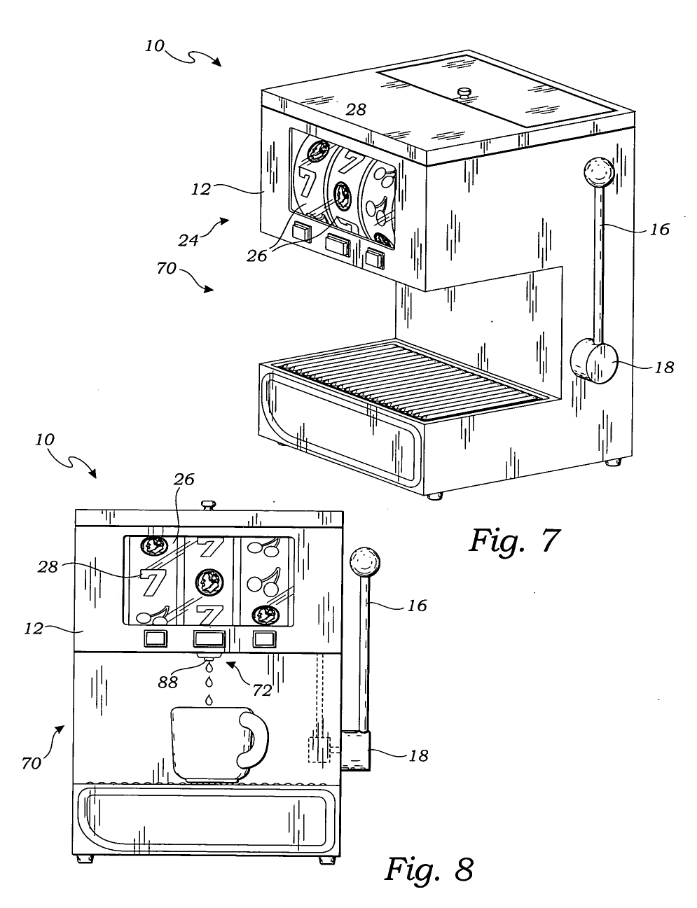

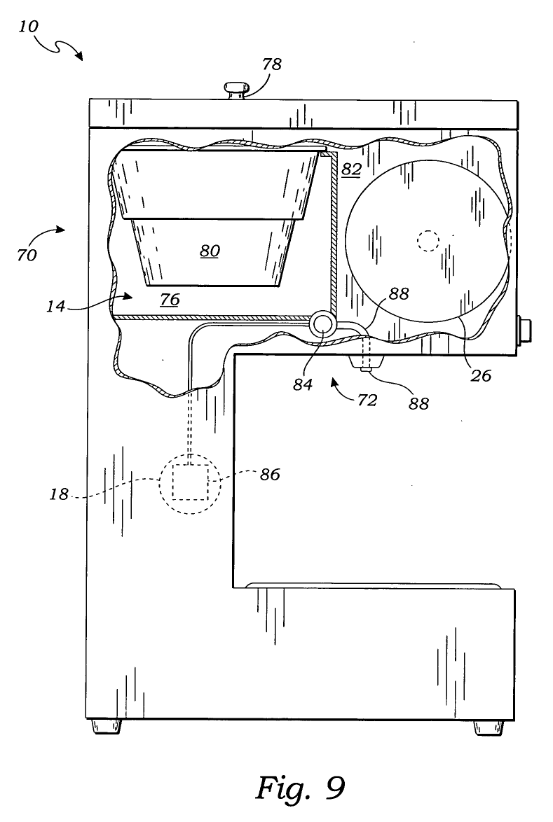

In a third embodiment, illustrated in FIGS. 7-9, the useful device 10 is a coffee machine 70, and the useful feature 14 is a beverage dispensing mechanism 72 for dispensing a beverage. FIG. 7 is a perspective view of the coffee machine 70. FIG. 8 is a front elevational view thereof, and FIG. 9 is a side elevational view thereof. In FIG. 9, a portion of the slot coffee machine 70 broken away to illustrate the internal construction of the slot coffee machine 70.

In the embodiment of FIGS. 7-9, the coffee machine 70 is preferably generally similar in construction to a prior art coffee machine 70; however, a façade of the coffee machine 70 resembles a slot machine, and the slot arm 16 functions to activate the beverage dispensing mechanism.

In the preferred embodiment, the coffee machine 70 includes a rear upper compartment 76 that includes a lid 78 for covering a filter holder 80 through which hot water is added (or cold water, if a heater (not shown) is included). A front upper compartment 82 includes the reels 26 of the slot machine. The beverage dispensing mechanism 72 includes a valve 84 operably controlled by a valve controller 86 that is operably connected to the slot arm 16. The valve 84 allows fluid to flow through a conduit 88 and out of the coffee machine 70 when the slot arm 16 is pulled.

While one embodiment of the beverage dispensing mechanism 72 is illustrated herein, those skilled in the art may devise many alternative embodiments of mechanisms for dispensing coffee, espresso, or other forms of beverages, consistent with dispensers well known in the art, and such alternatives should be considered within the scope of the present invention.

While at least one preferred embodiment of the present invention is illustrated above, it should be understood that the presently claimed invention includes alternative embodiments that could be devised by those skilled in the art. The terminology used above should be construed to include the words described above, as well as similar or equivalent words, or derivatives thereof. Additionally, the words “a,” “an,” and “one” are defined to include one or more of the referenced item unless specifically stated otherwise. Also, the terms “have,” “include,” “contain,” and similar terms are defined to mean “comprising” unless specifically stated otherwise.

While the invention has been described with reference to at least one preferred embodiment, it is to be clearly understood by those skilled in the art that the invention is not limited thereto. Rather, the scope of the invention is to be interpreted only in conjunction with the appended claims.

What is claimed is:

1. A useful device adapted to resemble a slot machine, the useful device comprising:
a device body having a useful feature for performing a task;
a façade of the useful device resembling a slot machine; and
a slot arm operably connected to the device body, the slot arm functioning to actuate the useful feature of the useful device.

2. The useful device of claim 1, wherein the façade includes a plurality of reels, each reel including a plurality of slot symbols.

3. The useful device of claim 2, wherein the useful device further includes a spin mechanism for spinning the plurality of reels, and a control mechanism for stopping each of the plurality of reels at various periods of time.

4. The useful device of claim 1, wherein the useful device is a toaster.

5. The useful device of claim 4, wherein the useful feature is a food holding mechanism for holding a food product, and the slot arm functions to lower the food holding mechanism to a position adjacent a heater element.

6. The useful device of claim 1, wherein the useful device is a pepper dispenser.

7. The useful device of claim 6, wherein the useful feature is a pepper grinding mechanism for grinding and dispensing pepper, and the slot arm functions to activate the pepper grinding mechanism.

8. The useful device of claim 1, wherein the useful device is a coffee machine.

9. The useful device of claim 8, wherein the useful feature is a beverage dispensing mechanism for dispensing a beverage, and the slot arm functions to activate the beverage dispensing mechanism.

10. A slot machine toaster for toasting a food product, the slot machine toaster comprising:
a toaster body having an aperture for receiving the food product;
a façade of the toaster body resembling a slot machine;
a heater element operably mounted within the toaster body;
a food holding mechanism for receiving the food product through the aperture; and
a slot arm operably connected to the toaster body, the slot arm functioning to actuate the food holding mechanism for lowering the food product into the toaster body adjacent the heater element.

11. The slot machine toaster of claim 10, wherein the façade includes a plurality of reels, each reel including a plurality of slot symbols.

12. The slot machine toaster of claim 11, wherein the useful device further includes a spin mechanism for spinning the plurality of reels, and a control mechanism for stopping each of the plurality of reels at various periods of time.
